(19) United States
(12) Patent Application Publication
(10) Pub. No.: US 2013/0170911 A1
(43) Pub. Date: Jul. 4, 2013

(54) METHOD OF RESTORING CONTAMINATED LAND

(71) Applicant: Quinton Clive Richards, Rotherfield (GB)

(72) Inventor: Quinton Clive Richards, Rotherfield (GB)

(73) Assignee: LICHEN PROPERTIES LIMITED, Berkshire (GB)

(21) Appl. No.: 13/704,535

(22) PCT Filed: Jun. 17, 2011
(86) PCT No.: PCT/GB11/51132

§ 371 Date: Mar. 13, 2013

(30) Foreign Application Priority Data
Jun. 17, 2010 (GB) 1010189.7

(51) Int. Cl. B09C 1/08

(52) U.S. Cl. CPC B09C 1/08
USPC 405/128.75

(57) ABSTRACT

A method of restoring contaminated land, for example landfill (12), comprises covering the surface of the land with a substantially uninterrupted layer of a composition including pulverised fly ash mixed with lime, the preparation creating a pozzolanic pan (14). At least one soil horizon comprising varying mixtures of pulverised fly ash, biochar and secondary treated sewage sludge or other organic material is laid over the pozzolanic pan (14).

The present invention relates to a method of restoring contaminated land and particularly, but not exclusively, to landfill sites.

### BACKGROUND TO THE INVENTION

At present, the availability of contaminated land for re-use, such as for new buildings, roads, domestic and commercial orchards, vineyards, gardens and sports pitches, is very limited, because the contamination can be potentially toxic for many years, thereby posing a serious health and safety risk. Furthermore, the contamination may prevent or limit plant growth.

At former landfill sites, depending on the age of the site and the type of buried waste, the waste typically produces one or more gases as by-products of natural degradation. Such gases, in particular, the so-called ‘greenhouse gases’ such as methane and carbon dioxide are harmful to the environment.

Furthermore, as rain water percolates through the landfill, the water is contaminated by decomposing waste and forms a leachate. This leachate typically enters the local water table, polluting the local environment and potentially putting the health and safety of the local population at risk. Additional leachate is generally produced during the decomposition of carbonaceous material.

To mitigate these problems, it is known to produce engineered landfill sites, that are either built on geographically impermeable materials or that use an impermeable liner made of geotextiles or engineered clay. The use of such linings is now mandatory in certain countries, depending on the nature of the contamination. However, many landfill sites already in existence do not benefit from such linings. Furthermore, attempts to cap landfill sites with clay to try and prevent water ingress are often unsuccessful, because over time, the clay dries out and cracks, thereby allowing the ingress of rain water.

It is therefore an object of the invention to provide an improved method of restoring contaminated land such as landfill to beneficial use, the method reducing leachate into the water table and gas emission to atmosphere.

### STATEMENT OF INVENTION

According to the present invention there is provided a method of restoring contaminated land comprising covering the surface of the land with a substantially uninterrupted layer of a preparation including pulverised fly ash mixed with lime, the layer creating a pozzolanic pan, and laying at least one soil horizon over the pozzolanic pan, the or each soil horizon including at least some biochar, the biochar having been pyrolised from biomass, wherein pyrolysis of the biomass is effected with methane gas extracted from landfill.

The method is advantageous because it provides environmental improvements to contaminated land so that it can be reclaimed for subsequent economically valuable use, such as growing high value crops, for example a commercial vineyard and/or integrated recreational and educational facilities.

The pozzolanic pan effectively caps the site from upward migration of gases, which may be tapped using bore holes. The capping also provides a barrier against the ingress of rain and hence significantly reduces leachates entering the water table from the contaminated land, for example landfill.

The pozzolanic pan facilitates the harvesting or tapping of the waste gases for subsequent use, for example, in the pyrolysis of biomass. Preferably, before the composition is laid, the site is landscaped to provide slopes. In use, these slopes direct any rainwater away from the site into lagoons, from where the water can be piped for use.

The method is environmentally friendly as it minimises the use of recovered materials that would otherwise have to be disposed of. Pulverised fly ash is a waste by-product of coal fire stations.

One or more soil horizons are laid over the preparation layer. These engineered soil horizons may be adapted for specific end users of the reclaimed contaminated land. For example, the composition of the layers may be manipulated to balance adequate drainage with a good water holding capacity, making the contaminated land particularly conducive for use in agriculture.

The layers may also be adapted to provide adequate aeration of the vine root system, which is essential to avoid root asphyxiation, a problem that commonly occurs in badly compacted soils.

Since each of the layers is not a hard pan, they are not barriers to root penetration.

Use of biochar is environmentally friendly because it stores carbon, hence reducing carbon dioxide emissions.

Preferable and/or optional features of the invention are set forth in claims 2 to 27.

### DESCRIPTION OF DRAWINGS

For a better understanding of the present invention, and to show more clearly how it may be carried into effect, reference will now be made, by way of example only, to the accompanying drawing, in which:

FIG. 1 shows a schematic cross-section of a landfill cap having a pozzolanic layer and a series of engineered soil horizons.

### DESCRIPTION OF PREFERRED EMBODIMENT(S)

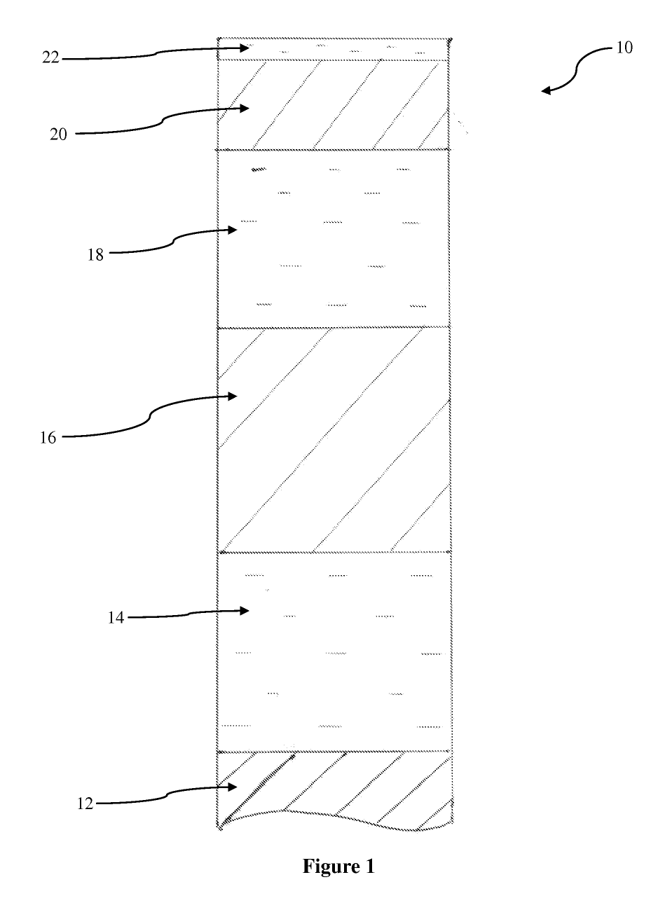

Referring to FIG. 1, a section through a capped landfill site is indicated generally at 10. The landfill site 10 includes a deposit of waste material or landfill 12 that has typically been collected from the local municipality and transported to the landfill site for long term storage. This waste material 12 essentially contaminates the land as previously described unless treated, for example in a manner as described below.

A pozzolanic layer or hard pan 14 is laid above the waste material 12. This pozzolanic layer is composed of pulverised fly ash (PFA) mixed with lime. PFA is a waste product of coal fired power stations. PFA distributed in the presence of free lime forms creates a hard impermeable pozzolanic pan over time. The hard pan effectively caps the waste material 12, preventing gases, such as methane and carbon dioxide, produced as by-products of bio-degradation from rising to the surface. It also provides a barrier to ingress of rainwater and/or groundwater. The pozzolanic layer is around 1 m to 1.5 m in thickness.

Although not shown in FIG. 1, the surface of the landfill is graded in one or more slopes such that the resulting pozzolanic layer 14 slopes. In this way, the by-product gases and liquids are directed to suitable collection points. The gas may be tapped and used as an energy source, for example for the pyrolysis of biomass. The water may be collected in a lagoon. In the context of grapevine growing, the grading of the site is carried out in such a way that it creates a slope that optimises insolation, to produce the greatest volume of grape harvest and capture of water for irrigation.

A series of engineered soil horizons, each having a particular composition, are then laid on top of the pozzolanic layer 14. The creation of a set of soil horizons above the hard cap enables the site to be brought into more beneficial uses such as agricultural production and recreational purposes consistent with current environmental health and safety requirements.

A first soil horizon 16, a “C” horizon, is laid directly on top of the pozzolanic layer 14, and is a composition of PFA and biochar. The role of the biochar is to help balance drainage within the soil layer with the capacity of the PFA to hold water whereas the PFA helps to prevent nutrient leaching. The C soil horizon 16 acts as a foundation layer and may also typically contain large stones and/or crushed brick, preferably recycled. The layer 14 is around 1.5 m thick and is situated at a depth between 2 and 3.5 m from the completed site surface.

The biochar is pyrolised using methane tapped through the pozzolanic layer 14. Advantageously, the biochar can be slowly pyrolised at low temperatures and incubated for 2-months, the effective pH being lowered to an average of pH 2-3 which neutralises the high pH values encountered from untreated PFA. Where the pH remains higher and free boron remains elevated, the soil is nonetheless suitable for the growing of Vinus vitecultera (the common grape vine) which is boron and pH tolerant. The pyrolisis of biochar sequestrates carbon in a stable format, the residence time of which is in excess of 1000 years. This therefore contributes to environmental aims of greenhouse gas emission reduction.

A second soil horizon 18, horizon “B”, is laid over the first soil horizon 16, and it is also primarily a blend of PFA and biochar. By way of example, the composition of the second soil horizon 18 may be 60% PFA to 40% biochar by volume. However, the second soil horizon 18 may also include stone, sand, silt and organic matter, such as secondary treated sewage sludge, known as cake. The sewage sludge is an active NPK (Nitrogen Phospohorus Potassium) fertiliser and supplies organic matter to the soil. The amount of organic matter within the second soil horizon 18 is less than 1% by volume. The second soil horizon 18 is around 1.5 m in thickness and is situated at a depth of around 0.5 m and 2.0 m from the completed site surface.

A third soil horizon 20, horizon “A”, is laid on top of the second soil horizon 18 and is also a mixture of PFA and biochar in the proportions of 57% PFA and 40% biochar by volume. Less than 3% by volume of the blend is organic matter provided by secondary treated sewage sludge. The majority of mineral nutrients will be held in this horizon. The third soil horizon is around 0.4 m in thickness and is situated at around 0.1 m to 0.5 m from the completed site surface.

A fourth soil horizon 22, horizon “O, is located at the completed site surface, and is typically 0.1 m deep. It also contains a blend of PFA and biochar, with there being approximately 45% biochar and 25% PFA by volume. The fourth soil horizon 22 contains a higher proportion of organic matter than the other soil horizons, at around 30% by volume, for example secondary treated sewage sludge, and has a relatively low mineral content.

The presence of biochar throughout the soil horizons engenders free draining characteristics and its inherent adsorptive retentive characteristics allow the nutrient elements from the organic sewage sludge to be made available for an optimised growing medium.

The use of engineered soil horizons facilitates good soil drainage which is desirable for crop cultivation because it encourages the soil to warm up quickly. It is well established in gardening that waterlogged soil warms up more slowly that drier soil. Warmer soils are generally beneficial as they stimulate root activity and consequently shoot growth in the Spring.

In brief, the artificial soil duplicates the natural soil characteristics of a silty clay loam by replacing inert fine particle materials such as silt and clay with PFA and large particles such as sand and gravel with biochar. The artificial soil is an enhanced growing medium for crops and an additional surface upon which recreation can take place safely having regard to current health and safety legislation.

It will be understood that the depth or thickness of the various soil horizons can be varied to suit particular landfill or contaminated land sites. Furthermore, the composition of the various soil horizons may also be varied to suit a particular location. The soil horizons described may be used in isolation or in any combination with the pozzolanic layer.

1. A method of restoring contaminated land comprising;
covering the surface of the land with a substantially uninterrupted layer of a composition including pulverised fly ash mixed with lime, the layer creating a pozzolanic pan, and laying at least one soil horizon over the pozzolanic pan, at least one soil horizon including at least some biochar, the biochar having been pyrolised from biomass, wherein pyrolysis of the biomass is effected with methane gas extracted from landfill.

2. A method as claimed in claim 1, in which a plurality of soil horizons, each having a separate composition, are laid over the pozzolanic pan.

3. A method as claimed in claim 1, in which a first soil horizon is laid over the pozzolanic pan, the first soil horizon having a composition including pulverised fly ash mixed with biochar.

4. A method as claimed in claim 3, in which the composition of the first soil horizon also includes stone and/or crushed brick.

5. A method as claimed in claim 3, in which a second soil horizon is laid over the first soil horizon, the second soil horizon having a composition including pulverised fuel ash and biochar.

6. A method as claimed in claim 5, in which the composition of the second soil horizon also includes stone and/or sand and/or silt.

7. A method as claimed in claim 3, in which the composition of the second soil horizon also includes organic matter.

8. A method as claimed in claim 7, in which the composition of the second soil horizon includes less than 1% organic matter by volume.

9. A method as claimed in claim 5, in which the composition of the second soil horizon includes around 60% pulverised fuel ash and around 40% biochar by volume.

10. A method as claimed in claim 5, in which a third soil horizon is laid over the second soil horizon, the third soil horizon having a composition including pulverised fuel ash and biochar.

11. A method as claimed in claim 10, in which the composition of the third soil horizon also includes stone and/or sand and/or silt.

12. A method as claimed in claim 10, in which the composition of the third soil horizon also includes organic matter.

13. A method as claimed in claim 10, in which the composition of the third soil horizon includes less than 3% organic matter by volume.

14. A method as claimed in claim 10, in which the composition of the third soil horizon includes around 57% pulverised fuel ash and around 40% biochar by volume.

15. A method as claimed in claim 10, in which a fourth soil horizon is laid over the third soil horizon, the fourth soil horizon having a composition including pulverised fuel ash and biochar.

16. A method as claimed in claim 15, in which the composition of the fourth soil horizon also includes gravel and/or sand and/or silt.

17. A method as claimed in claim 15, in which the composition of the fourth soil horizon also includes organic matter.

18. A method as claimed in claim 15, in which the composition of the fourth soil horizon includes around 30% organic matter by volume.

19. A method as claimed in claim 15, in which the composition of the fourth soil horizon includes around 25% pulverised fuel ash and around 45% biochar by volume.

20. A method as claimed in claim 1, in which the thickness of the layer creating the pozzolanic pan is around 1.5 m, the thickness of a first soil horizon laid over the pozzolanic pan is around 1.5 m, the thickness of a second oil horizon laid over the first soil horizon is around 1.5 m, the thickness of a third soil horizon laid over the second soil horizon is around 0.4 m, and the thickness of a fourth soil horizon laid over the third soil horizon is up to around 0.1 m.

21. A method as claimed in claim 1, in which the composition of at least a second soil horizon laid over the pozzolanic pan includes a portion of sewage sludge.

22-28. (canceled)
